(19) United States
(12) Patent Application Publication
(10) Pub. No.: US 2017/0291722 A1
(43) Pub. Date: Oct. 12, 2017

(54) METHODS AND SYSTEMS FOR PROVIDING A DATA-DRIVEN AIRCRAFT HEALTH REPORT

(71) Applicant: Gulfstream Aerospace Corporation, Savannah, GA (US)

(72) Inventors: Benjamin Owens, Savannah, GA (US); Gary Palfreyman, Savannah, GA (US); James Gallagher, Savannah, GA (US); Richard Wagner, Savannah, GA (US)

(21) Appl. No.: 15/093,056

(22) Filed: Apr. 7, 2016

(51) Int. Cl. B64F 5/00; G07C 5/08; G05B 23/00

(52) U.S. Cl. CPC B64F 5/0045; G05B 23/00; G07C 5/0808; B64D 2045/0085

(57) ABSTRACT

In one embodiment, a method for monitoring performance of an aircraft against maximum aircraft performance specifications during flight is provided. The method receives, by a processor on the aircraft, a plurality of sensor signals from a respective plurality of sensors onboard the aircraft and individually compares each of the plurality of sensor signals to a respective maximum aircraft performance specification. If an exceedance of a maximum aircraft performance specification is detected, information related to such occurrence of exceeding the maximum aircraft performance specification is recorded. The recorded information would be used to provide a report presenting the information related to the occurrence of exceeding the maximum aircraft performance specification.

### TECHNICAL FIELD

Embodiments of the present invention generally relate to aircraft, and more particularly relate to methods and systems for monitoring operation of an aircraft against maximum or not-to-exceed specifications and reporting any exceedance of such specifications.

### BACKGROUND

Contemporary aircraft are designed against strict performance specifications developed by an aircraft manufacturer to ensure safe and reliable air travel during the service life of the aircraft. For example, should an aircraft exceed a maximum acceleration specification or attitude specification, pressure forces applied to the fuselage of the aircraft may exceed the pressure the fuselage was designed to withstand. It is possible that exceeding the maximum altitude specification may cause a weakening of the fuselage that is not detectable by a visual or mechanical inspection of the aircraft. This condition may worsen if repeated or prolonged exceedances of the maximum specifications are experienced by the aircraft.

Conventional tracking of any performance specification exceedances and any corrective action taken following such exceedances is typically recorded in an aircraft log book. While an aircraft log book is intended to be meticulously kept, log book entries are self-reported by pilots and ground crew, and human data entry may lead to human error in such entries.

Accordingly, there is a need for methods and systems for monitoring the operation of an aircraft against a manufacture's maximum specifications. It would be desirable to provide methods and systems that can report to an aircraft owner or potential buyer of any exceedances of these maximum performance specifications. Furthermore, other desirable features and characteristics of the present invention will become apparent from the subsequent detailed description and the appended claims, taken in conjunction with the accompanying drawings and the foregoing technical field and background.

### BRIEF SUMMARY

In one non-limiting embodiment, a method for monitoring performance of an aircraft against maximum aircraft performance specifications during flight is provided. The method receives, by a processor on the aircraft, a plurality of sensor signals from a respective plurality of sensors onboard the aircraft and individually compares each of the plurality of sensor signals to a respective maximum aircraft performance specification. If an exceedance of a maximum aircraft performance specification is detected, information related to such occurrence of exceeding the maximum aircraft performance specification is recorded. The recorded information may be used to provide a report presenting the information related to the occurrence of exceeding the maximum aircraft performance specification.

In another non-limiting embodiment, an aircraft is provided having a fuselage having flight control surfaces attached thereto, one or more engines coupled to the fuselage to propel the aircraft and landing gear coupled to the fuselage and configured to facilitate movement of the aircraft while not in flight. A plurality of sensors are positioned on the aircraft, each of the plurality of sensors providing a sensor signal representing a performance parameter of the aircraft during flight. The aircraft includes a computer system coupled to the plurality of sensors, the computer system comparing each of the plurality of sensor signals to a respective maximum aircraft performance specification, and recording information related to an occurrence of exceeding the respective maximum aircraft performance specification. A report presenting the information related to the occurrence of exceeding the respective maximum aircraft performance specification may be provided periodically or on demand.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is an illustration of an aircraft in accordance with a non-limiting embodiment;

FIG. 2 is an illustration of various sub-systems of the aircraft of FIG. 1 in accordance with a non-limiting embodiment;

FIG. 3 is a block diagram of a performance monitoring system accordance with a non-limiting embodiment;

FIG. 4 is a flow diagram illustrating a method in accordance with a non-limiting embodiment;

FIGS. 5A-B are illustrations of exemplary reports in accordance with a non-limiting embodiment; and

FIG. 6 is a table of exemplary maximum aircraft performance specifications in accordance with a non-limiting embodiment.

### DETAILED DESCRIPTION

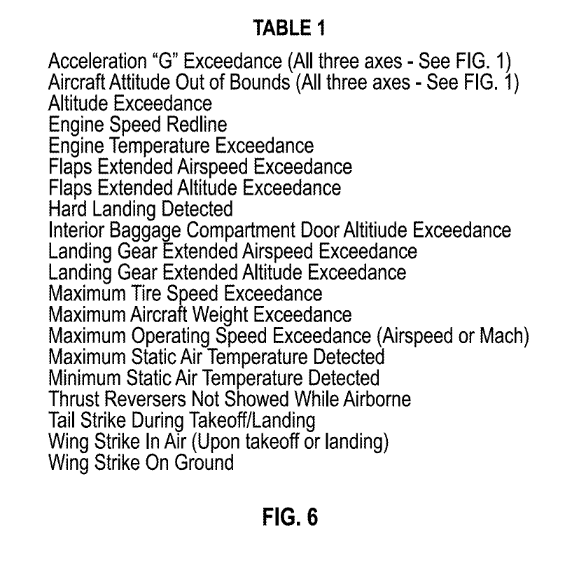

Systems and methods for a data-driven aircraft health report are disclosed herein. The aircraft health report is referred to as “data-driven” as the report is generated with actual aircraft performance data measured during flight. Sensor signals from various sensors positioned throughout the aircraft are compared against maximum aircraft performance specifications as set by the aircraft manufacturer. As used herein, “maximum aircraft performance specifications” means a set of specifications that are not to be exceeded during operation of the aircraft due to the risk of damage to the aircraft. Non-limiting examples of such specifications are illustrated in FIG. 6 as will be discussed below. Generally, however, maximum aircraft performance specifications comprise a set of specifications safeguarding the aircraft structural integrity or overall safe operation including the fuselage, flight control surfaces and landing gear (including tires). As discussed above, one example of a maximum aircraft performance specification would be maximum aircraft altitude. If the aircraft were to exceed the maximum aircraft acceleration specification or attitude specification during flight, the fuselage may experience forces in excess of that which the fuselage was designed to withstand. Another example of a maximum aircraft performance specification is a hard landing detection, that may damage the landing gear or tires. Yet another example would be detecting a “hot landing”, where maximum tire speed may be exceeded. In many cases, exceedances of maximum aircraft performance specifications may not be detected by visual or mechanical preflight inspections.

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention, which is defined by the claims. Furthermore, there is no intention to be bound by any theory presented in the preceding background or the following detailed description.

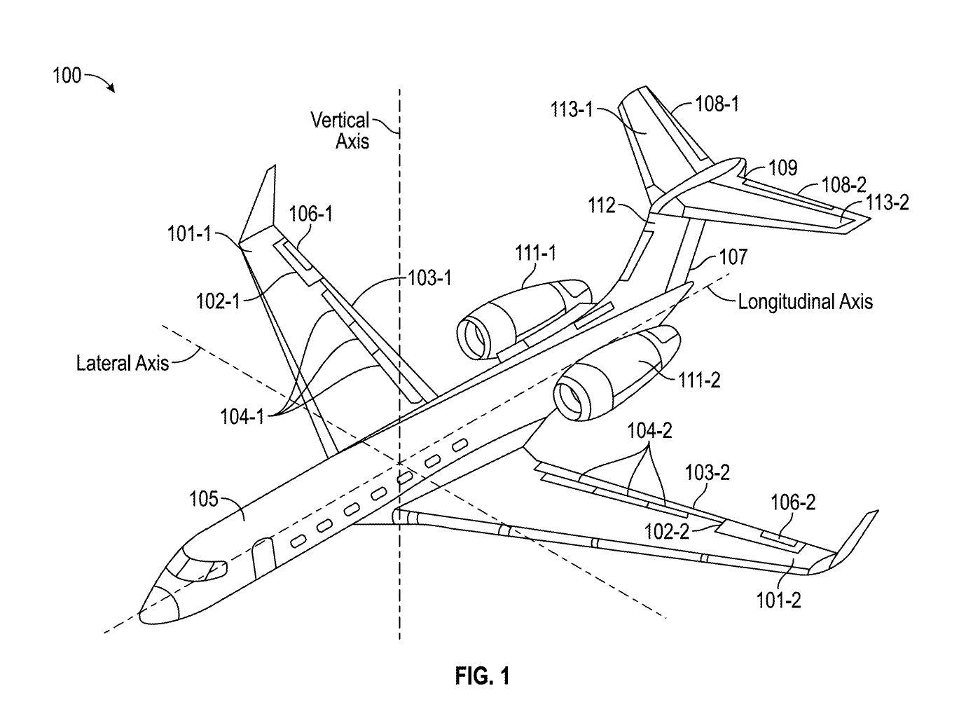

FIG. 1 is a perspective view of an aircraft 100 that can be used in accordance with the exemplary disclosed embodiments. In accordance with one non-limiting implementation, the aircraft 100 includes a fuselage 105, including various flight control surfaces. Non-limiting embodiments of flight control surfaces includes: two main wings 101-1, 101-2, a vertical stabilizer 112, a horizontal tail that is comprised of two horizontal stabilizers 113-1 and 113-2 in a T-tail stabilizer configuration, and two jet engines 111-1, 111-2. Additionally, the two main wings 101-1, 101-2 each have an aileron 102-1, 102-2, an aileron trim tab 106-1, 106-2, a spoiler 104-1, 104-2 and a flap 103-1, 103-2, while the vertical stabilizer 112 includes a rudder 107, and the aircraft's horizontal stabilizers (or tail) 113-1, 113-2 each include an elevator 109 and elevator trim tab 108-1, 108-2. Although not shown in FIG. 1, the aircraft 100 also includes onboard computers, aircraft instrumentation, landing gear and various flight control systems and sub-systems as described below.

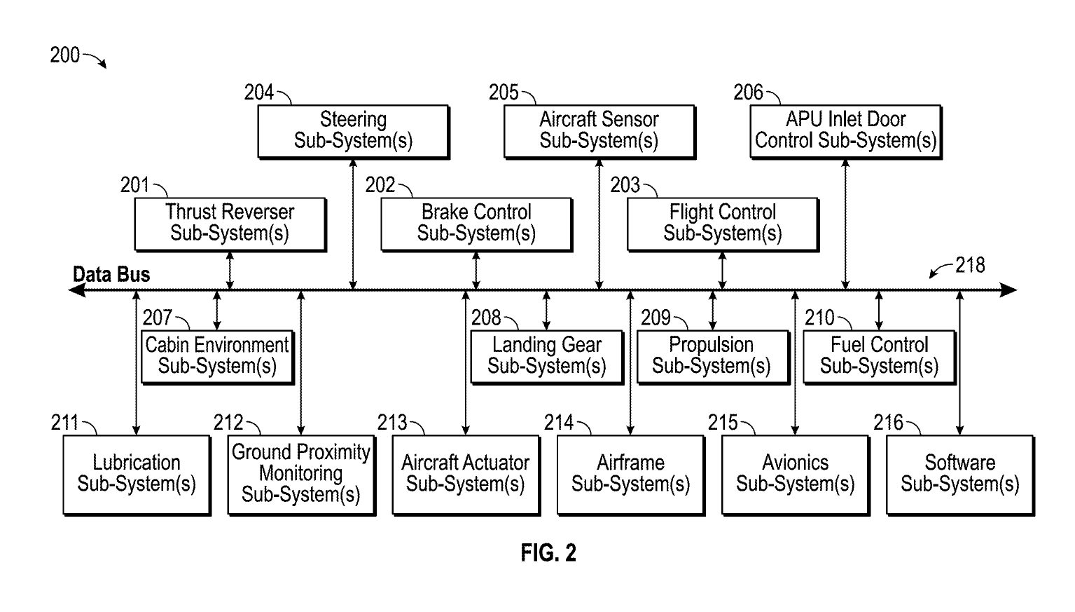

FIG. 2 is a block diagram of various sub-systems 200 of an aircraft 100 in accordance with an exemplary implementation of the disclosed embodiments. In one exemplary, non-limiting implementation, the various sub-system(s) 201-216 include a thrust reverser control sub-system(s) 201, a brake control sub-system(s) 202, a flight control sub-system(s) 203, a steering control sub-system(s) 204, aircraft sensor control sub-system(s) 205, an APU inlet door control sub-system(s) 206, a cabin environment control sub-system(s) 207, a landing gear control sub-system(s) 208, propulsion sub-system(s) 209, fuel control sub-system(s) 210, lubrication sub-system(s) 211, ground proximity monitoring sub-system(s) 212, aircraft actuator sub-system(s) 213, airframe sub-system(s) 214, avionics sub-system(s) 215, software sub-system(s) 216 each coupled to a data bus 218. The sub-system(s) 201-216 that are illustrated in FIG. 2 are exemplary only, and in other embodiments various other sub-system(s) can be included such as, for example, air data sub-system(s), auto flight sub-system(s), engine/power plant/ignition sub-system(s), electrical power sub-system(s), communications sub-system(s), fire protection sub-system(s), hydraulic power sub-system(s), ice and rain protection sub-system(s), navigation sub-system(s), oxygen sub-system(s), pneumatic sub-system(s), information sub-system(s), exhaust sub-system(s), etc.

Although not illustrated in FIG. 2, those skilled in the art will appreciate that each of the various sub-systems can include one or more components. In addition, each of the various sub-systems can each include one or more sensors to facilitate measurement and generation of data pertaining to operation of that sub-system of the aircraft 100 (and/or a component of that sub-system), to assist in performing diagnostics and health monitoring of one or more sub-systems, etc. For critical sub-subsystems, it is common to have redundant sensors (e.g., triple redundant or quad-redundant) in the event of sensor failure. Each sensor can generate data that is used to provide information to the pilot during flight and to be used by aircraft maintenance personnel prior to or after flight. In general, a “sensor” is a device that measures a physical quantity and converts it into a signal which can be read by an observer or by an instrument. In general, sensors can be used to sense light, motion, temperature, magnetic fields, gravitational forces, humidity, vibration, pressure, electrical fields, current, voltage, sound, and other physical aspects of an environment. Non-limiting examples of sensors can include acoustic sensors, vibration sensors, air data sensors (e.g., air speed, altimeter, angle of attack sensor), inertial sensors (e.g., gyroscope, accelerometer, inertial reference sensor), magnetic compass, navigation instrument sensor, electric current sensors, electric potential sensors, magnetic sensors, radio frequency sensors, fluid flow sensors, position, angle, displacement, distance, speed, (e.g., inclinometer, position sensor, rotary encoder, rotary/linear variable differential transducers, tachometer, etc.), optical, light, imaging sensors (e.g., charge-coupled device, infra-red sensor, LED, fiber optic sensors, photodiode, phototransistors, photoelectric sensor, etc.), pressure sensors and gauges, strain gauges, torque sensors, force sensors, piezoelectric sensors, density sensors, level sensors, thermal, heat, temperature sensors (e.g., heat flux sensor, thermometer, resistance-based temperature detector, thermistor, thermocouple, etc.), proximity/presence sensors, etc.

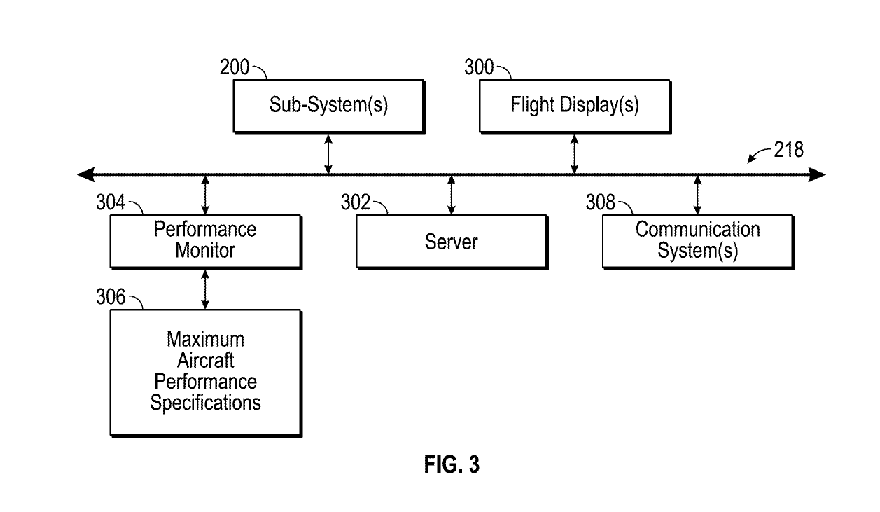

In FIG. 3, the various aircraft sub-systems 200 are illustrated coupled to the aircraft data bus 218 along with various other aircraft systems. The sensor signals from the aircraft sub-systems 200 are placed on the aircraft data bus 218 to be routed to various other systems. Some sensor signals (e.g., altitude, heading and air speed) are routed to flight displays 300 for presentation to the pilot during operation of the aircraft. Other sensor signals may be stored on a server 302 to be processed and analyzed at a later time.

With continuing reference to FIGS. 1-2, according to exemplary embodiments, the aircraft 100 includes a performance monitor 304 that receives sensor signals from the aircraft data bus 218 and compares the sensor signals to maximum aircraft performance specifications 306. In the embodiment illustrated in FIG. 3, the performance monitor 304 and the maximum aircraft performance specifications 306 are an independent system. In other embodiments, the maximum aircraft performance specifications 306 could be stored on the server 302 and accessed by the performance monitor 304. In still other embodiments, a software application performing the functions of the performance monitor 304 could also be stored on the server 302 along with the maximum aircraft performance specifications.

In operation, the performance monitor records a plurality of sensor signals for comparison to a respective maximum aircraft performance specification. As a non-limiting example, the sensor signal from the aircraft altimeter sensor would be compared to the maximum aircraft altitude performance specification. In some embodiments, the plurality of sensor signals are recorded for a predetermined time period (e.g., the last 3, 5 or 10 minutes) and may be stored periodically (e.g., every 3, 6 or 11 seconds) during the time period. So long as a maximum aircraft performance specification is not exceeded, older data is discarded so that only the last predetermined time period of data remains. Upon detecting that a maximum aircraft performance specification has been exceeded, information related to the specification exceedance is recorded. In some embodiments, the information related to the specification exceedance is saved for a time period prior to the specification exceedance, for a time period of the specification exceedance and for a third time period following the end of the specification exceedance. Having recorded information prior to the specification exceedance can be helpful in analyzing the nature of the specification exceedance. For example, if aircraft altitude was rapidly increasing a minute before the maximum aircraft altitude specification was exceeded the exceedance could have been an intentional act. Conversely, if aircraft altitude was rising gradually in the minute prior to the specification exceedance then exceeding the maximum aircraft altitude specification could have been inadvertent error. Similarly, recording information related to the specification exceedance after the aircraft returns to be within the maximum aircraft performance specification may also be useful in analyzing the event. In other embodiments, information directly related to the specification exceedance (e.g., the date, time and duration) may be recorded without information surrounding the specification exceedance which requires less memory and processor time.

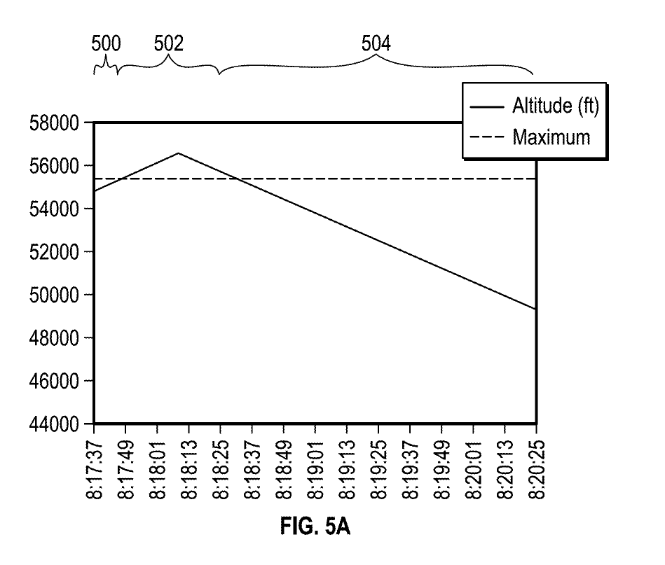

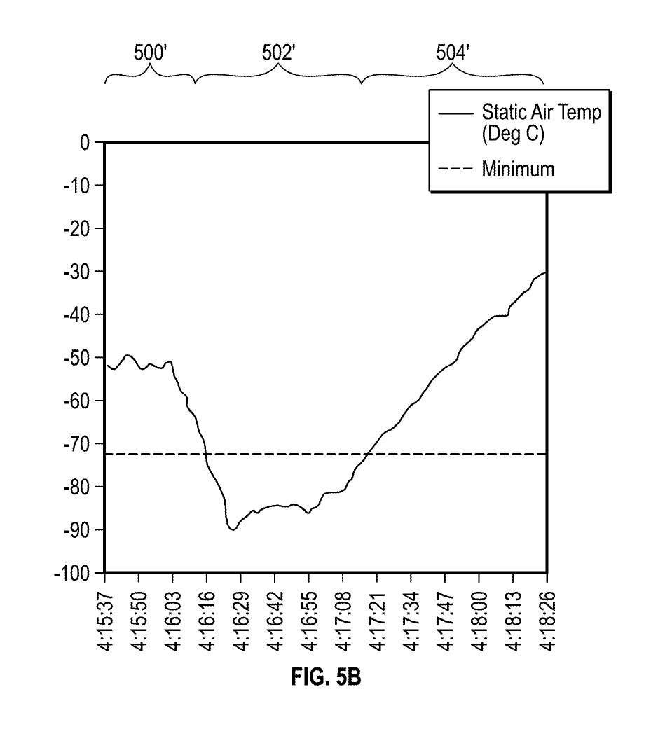

According to exemplary embodiments, a data-driven aircraft health report can be generated to list any exceedances of the maximum aircraft performance specifications. This report can be used to verify the aircraft logbook for accuracy, or may be requested by a potential purchaser of an aircraft for assurance of the aircraft has been operated safely. In some embodiments, the report may be automatically generated by the performance monitor 304 and communicated (e.g., email) to a recipient by the communication systems 308. In other embodiments, the report can be generated on demand, which typically is done when the aircraft is not in flight at a ground station. Non-limiting embodiments of such reports are illustrated in FIG. 5 as will be discussed below.

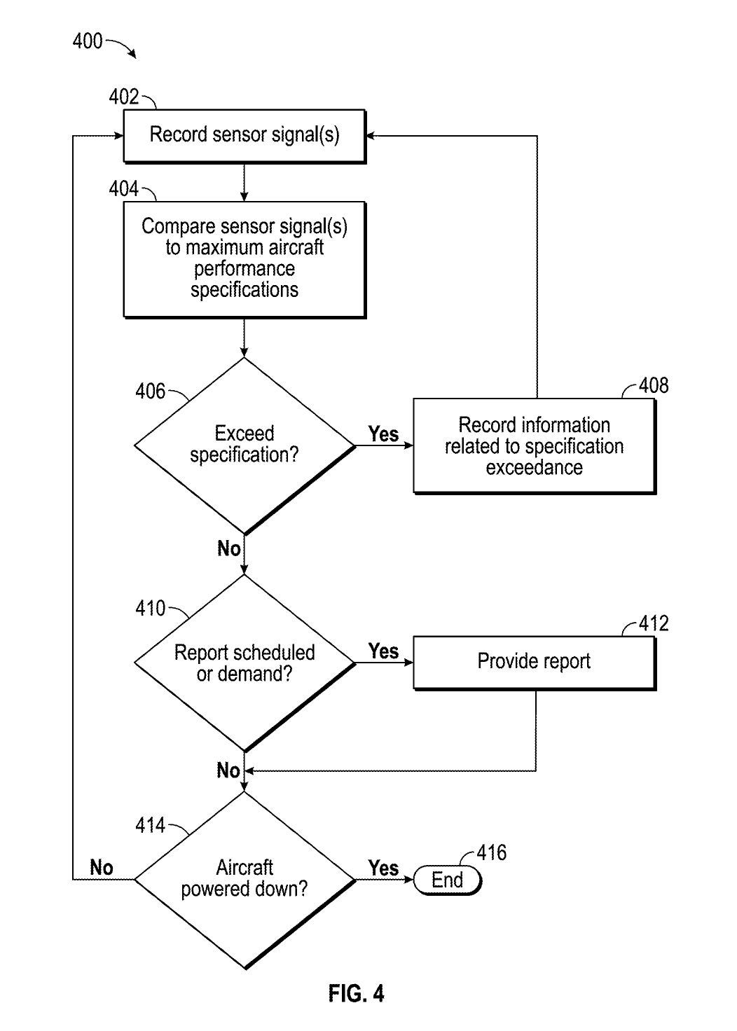

FIG. 4 is a flow diagram illustrating a method 400 in accordance with an embodiment. With continuing reference to FIGS. 1-3, in some embodiments, the method 400 is performed by the performance monitor 304. In other embodiments, a non-transitory computer program residing on the server 302 may perform the method 400. The routine begins in block 402, where various sensor signals are recorded during flight. In some embodiments, the sensor signals are recorded for a predetermined time period (e.g., the last 5 minutes) by the performance monitor 304. In block 404, the sensor signals are compared to the maximum aircraft performance specifications 306 to determine in block 406 whether any sensor signal indicates that a maximum aircraft performance specification has been exceeded. If so, the routine proceeds to block 408 or information related to the specification exceedance is recorded. As noted above, in some embodiments information occurring a time period prior to the specification exceedance, during the specification exceedance and a third time period following the end of the specification exceedance are recorded. Conversely, if the determination of block 406 is that no sensor signal has exceeded a respective maximum aircraft performance specification, the routine proceeds to block 410 which determines whether a report has been demanded or is scheduled to be delivered. If so, the report is provided in block 412 and the routine continues to block 414, which determines whether the aircraft is still powered on. If not, the routine ends in block 416, however, if the aircraft remains powered on the routine returns to block 404 and repeats while the aircraft is powered on.

FIG. 5A and FIG. 5B illustrate non-limiting examples of a data-driven aircraft health report. In FIG. 5A, the maximum aircraft altitude specification has been exceeded. As can be seen, information is recorded and presented in the report for a time period 500 prior to exceeding the maximum aircraft altitude specification, for the time period 502 during which the aircraft was above the aircraft maximum altitude specification, and for a third time period 504 after which the aircraft proceeded below the maximum aircraft altitude specification. Similarly in FIG. 5B, a static air temperature specification exceedance has been detected. This causes information to be recorded related to the specification exceedance for a time period 500′, the time period 502′ and the third time period 504′.

In FIG. 6, a non-limiting list of exemplary maximum performance aircraft specifications is presented in Table 1. As can be seen, these maximum aircraft performance specifications relate generally to the integrity of the aircraft fuselage (e.g., aircraft altitude, attitude and maximum weight), flight control surfaces (e.g., tail strike, wing strike and flaps) and landing gear (e.g., hard landing, maximum tire speed and landing gear extended air speed and altitude). In any exemplary embodiment, all or some of these maximum aircraft performance specifications can be selected as desired any particular implementation. Additionally, it will be appreciated by those skilled in the art that other maximum aircraft specifications not listed in Table 1 may be added if desired by any particular aircraft manufacturer.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method for monitoring performance of an aircraft against maximum aircraft performance specifications during flight, comprising:
receiving, by a processor on the aircraft, a plurality of sensor signals from a respective plurality of sensors onboard the aircraft;
individually comparing each of the plurality of sensor signals to a respective maximum aircraft performance specification and recording information related to any occurrence of exceeding the respective maximum aircraft performance specification; and
providing a report presenting the information related to the occurrence of exceeding the respective maximum aircraft performance specification.

2. The method of claim 1, further comprising recording the plurality of sensor signals for a predetermined time period regardless of whether a respective maximum aircraft performance specification has been exceeded.

3. The method of claim 2, wherein recording the plurality of sensor signals comprises periodically recording the sensor signal.

4. The method of claim 2, wherein the recording of the plurality of sensor signals is maintained for a second predetermined time period prior to the occurrence of exceeding the respective maximum aircraft performance specification, during the occurrence of the respective maximum aircraft performance specification being exceeded and for a third predetermined time period after the occurrence of exceeding the respective maximum aircraft performance specification has ended.

5. The method of claim 1, wherein the report is automatically generated and transmitted to a recipient.

6. The method of claim 1, wherein the report is generated upon demand.

7. The method of claim 6, wherein the report is generated while the aircraft is not in flight.

8. A non-transitory computer readable medium embodying a computer program product, comprising:
a monitor program for comparing aircraft performance during flight against maximum aircraft performance specifications, that when executed on a computer system on an aircraft, the monitor program:
receives a plurality of sensor signals from a respective plurality of sensors onboard the aircraft;
individually compares each of the plurality of sensor signals to a respective maximum aircraft performance specification and records information related to any occurrence of exceeding the respective maximum aircraft performance specification; and
provides a report presenting the information related to the occurrence of exceeding the respective maximum aircraft performance specification.

9. The non-transitory computer readable medium of claim 8, wherein the monitor program records the plurality of sensor signals for a predetermined time period regardless of whether a respective maximum aircraft performance specification has been exceeded.

10. The non-transitory computer readable medium of claim 9, wherein the monitor program periodically records the plurality of sensor signals.

11. The non-transitory computer readable medium of claim 9, wherein the monitor program maintains the recordings of the plurality of sensor signals for a second predetermined time period prior to the occurrence of exceeding the respective maximum aircraft performance specification, during the occurrence of the respective maximum aircraft performance specification being exceeded and for a third predetermined time period after the occurrence of exceeding the respective maximum aircraft performance specification has ended.

12. The non-transitory computer readable medium of claim 9, wherein the monitor program automatically generates the report and transmits the report to a recipient.

13. The non-transitory computer readable medium of claim 9, wherein the monitor program generates the report upon demand.

14. An aircraft, comprising:
a fuselage having flight control surfaces attached thereto;
one or more engines coupled to the fuselage to propel the aircraft;
landing gear coupled to the fuselage and configured to facilitate movement of the aircraft while not in flight;
a plurality of sensors positioned on the aircraft, each of the plurality of sensors providing a sensor signal represented a performance parameter of the aircraft during flight; and
a computer system coupled to the plurality of sensors, the computer system comparing each of the plurality of sensor signals to a respective maximum aircraft performance specification, recording an information related to an occurrence of exceeding the respective maximum aircraft performance specification and providing a report presenting the information related to the occurrence of exceeding the respective maximum aircraft performance specification.

15. The aircraft of claim 14, further comprising the computer system recording the plurality of sensor signals for a predetermined time period regardless of whether a respective maximum aircraft performance specification has been exceeded.

16. The aircraft of claim 15, wherein recording the plurality of sensor signals comprises periodically recording the sensor signal.

17. The aircraft of claim 15, wherein the recording of the plurality of sensor signals is maintained for a second predetermined time period prior to the occurrence of exceeding the respective maximum aircraft performance specification, during the occurrence of the respective maximum aircraft performance specification being exceeded and for a third predetermined time period after the occurrence of exceeding the respective maximum aircraft performance specification has end.

18. The aircraft of claim 14, wherein the report is automatically generated and transmitted to a recipient.

19. The aircraft of claim 14 wherein the report is generated upon demand.

20. The aircraft of claim 14, wherein the report is generated while the aircraft is not in flight.
